(19) United States
(12) Patent Application Publication
(10) Pub. No.: US 2008/0137604 A1
(43) Pub. Date: Jun. 12, 2008

(54) METHOD AND SYSTEM FOR REDISTRIBUTION OF COMMUNICATION DEVICES IN A WIRELESS NETWORK

(75) Inventor: Miin-Nan Lee, Tempe, AZ (US)

Correspondence Address: MOTOROLA, INC., LAW DEPARTMENT, 1303 E. ALGONQUIN ROAD, SCHAUMBURG, IL, 60196, US

(73) Assignee: MOTOROLA, INC., Schaumburg, IL (US)

(21) Appl. No.: 11/608,318

(22) Filed: Dec. 8, 2006

(51) Int. Cl. H04Q 7/00

(52) U.S. Cl. 370/330

(57) ABSTRACT

A method and system for redistribution of a plurality of communication devices (114 to 120) from a first frequency band to a desired frequency band in a wireless network (100) is provided. The plurality of communication devices are in a slotted mode. The method includes dividing the plurality of communication devices into a first set and a second set of a plurality of communication devices. Further, the method includes transmitting a first configuration message to the first set of the plurality of communication devices during fractions of the slot cycle period. Moreover, the method includes redirecting each of the first set of the plurality of communication devices to the desired frequency band. Furthermore, the method includes transmitting a second configuration message to the plurality of the communication devices by the first BTS to suspend redirection events. Lastly, the method includes incrementing the transmission interval of the first configuration message per slot cycle period to the full slot cycle period to complete the redirection

### FIELD OF THE INVENTION

The present invention relates in general to a field of communication devices, and more specifically, to a method and system for redistribution of communication devices in a wireless network.

### BACKGROUND OF THE INVENTION

In modern communication systems, a base transceiver station (BTS) uses a common channel of a wireless network to send instructions to idle communication devices. These instructions are sent in the form of a configuration message. The configuration message is a public message or a broadcasting message that is sent periodically to idle communication devices by the BTS through the common channel. These configuration messages contain vital information pertaining to scanning and redirection of the communication devices. The configuration message, which includes redirection parameters, is also known as redirection message. The redirection message includes an access overload class and redirection parameters of each of the communication devices. Each communication device is pre-assigned an access control overload class (ACCOLC). The ACCOLC of a communication device defines its priority to communicate with another communication device. An ACCLOC is assigned to one or more communication devices. The ACCOLC varies from zero to nine for normal users of the communication devices, and from 10-16 for high priority users. The ACCOLC restricts a group of communication devices from accessing a Regional Area Network (RAN) without sending individual messages to the communication devices that are impacted.

The idle communication device can be in an ‘ON’ state or in an ‘OFF’ state. When in the ‘ON’ state, the communication device receives messages that are addressed to it from another communication device. Also when in the ‘ON’ state, the communication devices can receive the configuration messages including the redirection messages pertaining to its ACCOLC from the BTS. After receiving the redirection message, an idle communication device will decode and detect if there is a change in the redirection parameters encoded in the redirection message. For example, the idle communication device will look at a current sequence number of the redirection message and compare with a stored sequence number. If the idle communication device detects a change in the redirection parameters, it gets redirected to another BTS based on the encoded redirection parameters of the redirection message. If the idle communication device detects no change in the redirection parameters, the communication device enters the ‘OFF’ state.

Typically, simultaneous redirection of a number of communication devices from one BTS to another BTS after decoding the redirection parameters causes channel congestion. The channel congestion degrades the quality of communication.

### BRIEF DESCRIPTION OF THE DRAWINGS

The accompanying figures, where like reference numerals refer to identical or functionally similar elements throughout the separate views, and which, together with the detailed description below, are incorporated in and form part of the specification, serve to further illustrate various embodiments and explain various principles and advantages, all in accordance with the present invention.

FIG. 1 illustrates a wireless network where various embodiments of the present invention can be practiced;

FIG. 2 illustrates a block diagram of a first base transceiver station (BTS) of the plurality of BTS, in accordance with an embodiment of the present invention;

FIG. 3 represents a flow diagram illustrating a method for redistribution of a plurality of communication devices from a first BTS to a second BTS in a wireless network, in accordance with an embodiment of the present invention;

FIG. 4, 5 and 6 is an exemplary diagram illustrating the redistribution of the plurality of communication devices to the second BTS, in accordance with an embodiment of the present invention;

FIG. 7 is an exemplary diagram illustrating the redistribution of the plurality of communication devices to the second BTS, in accordance with another embodiment of the present invention; and

FIG. 8 shows a table displaying the time of the redirection of the plurality of communication devices, in accordance with various embodiments of the present invention.

Skilled artisans will appreciate that elements in the figures are illustrated for simplicity and clarity and have not necessarily been drawn to scale. For example, the dimensions of some of the elements in the figures may be exaggerated, relative to other elements, to help in improving an understanding of the embodiments of the present invention.

### DETAILED DESCRIPTION OF THE DRAWINGS

Before describing in detail the particular method and system for redistribution of communication devices in wireless communication network, in accordance with various embodiments of the present invention, it should be observed that the present invention resides primarily in combinations of method steps related to redistribution of communication devices in a wireless network. Accordingly, the apparatus components and method steps have been represented, where appropriate, by conventional symbols in the drawings, showing only those specific details that are pertinent for an understanding of the present invention, so as not to obscure the disclosure with details that will be readily apparent to those with ordinary skill in the art, having the benefit of the description herein.

In this document, the terms “comprises,” “comprising,” or any other variation thereof, are intended to cover a non-exclusive inclusion, such that a process, method, article or apparatus that comprises a list of elements does not include only those elements but may include other elements that are not expressly listed or inherent in such a process, method, article or apparatus. An element proceeded by “comprises . . . a” does not, without more constraints, preclude the existence of additional identical elements in the process, method, article or apparatus that comprises the element. The term “another,” as used in this document, is defined as at least a second or more. The terms “includes” and/or “having”, as used herein, are defined as comprising.

Various embodiments of the present invention provide a method for redistribution of a plurality of communication devices from a first frequency band to a desired frequency band in a wireless network. The plurality of communication devices are in a slotted mode. The method includes dividing the plurality of communication devices into a first set and a second of plurality of communication devices, based on a paging slot of each of the plurality of communication devices. The method also includes the transmission of a first configuration message by a first Base Transceiver Station (BTS) to the plurality of communication devices at a first predefined time interval of the paging slot cycle period. The first configuration message includes encoded redirection parameters pertaining to access control overload class count (ACCOLC) of each of the first set of the plurality of communication devices. Further, the method includes redirecting the first set of the plurality of the communication devices to the desired frequency band based on the first redirection message. Furthermore, the method includes transmission of a second configuration message to the plurality of communication devices by the first BTS at a second predefined time interval of the paging slot cycle period. The second configuration message includes encoded redirection parameters pertaining to ACCOLC for the first and second sets of the plurality of communication devices. Moreover, the method includes redirecting the second set of the plurality of communication devices to the desired frequency band based on the second redirection message.

Another embodiment of the present invention provides a BTS for redistribution of a plurality of communication devices in a wireless network. The BTS includes a divider to virtually divide the plurality of communication devices into a first set and a second set of the plurality of communication devices, based on a paging slot of each of the plurality of communication devices. Further, the BTS includes a transmitter that is capable of transmitting a first configuration message to the plurality of communication devices at a first predefined time interval. The first configuration message includes encoded redirection parameters pertaining to an access overload class of the first set of the plurality of communication devices. Furthermore, the transmitter is capable of transmitting a second configuration message to the plurality of communication devices at a second predefined time interval. The second configuration message includes encoded redirection parameters pertaining to the access overload class for the first set and the second set of the plurality of communication devices.

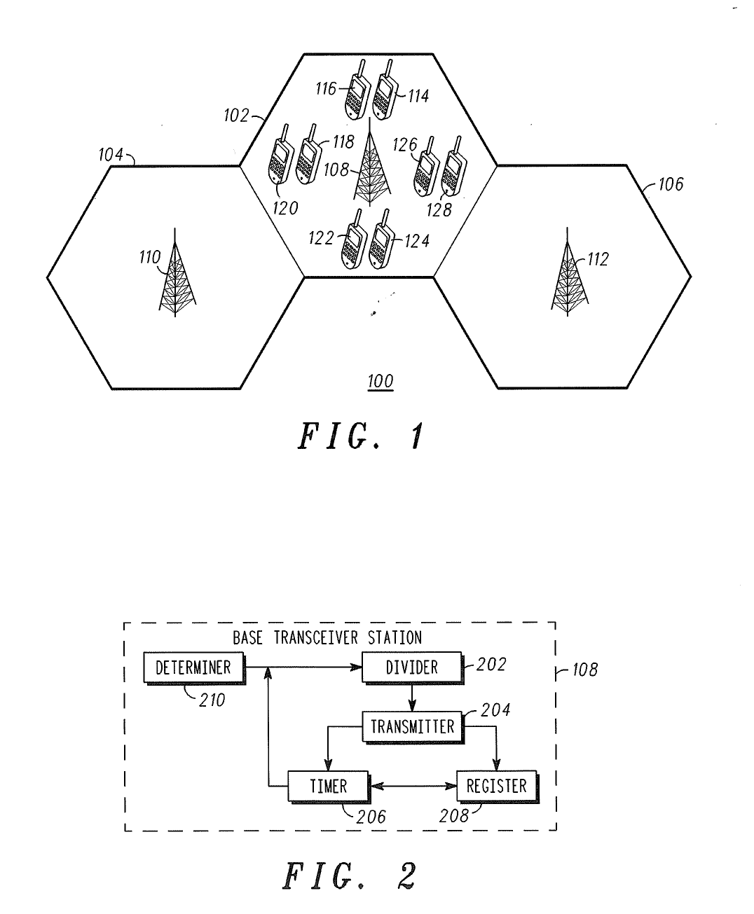

FIG. 1 illustrates a wireless network 100 where various embodiments of the present invention can be practiced. The wireless network 100 includes a first cell 102, a second cell 104, and a third cell 106. The first cell 102 has a first BTS 108 which is in a first frequency band f1. The second cell 104 has a second BTS 110 which is in another frequency band f2. The third cell 106 has a third BTS 112 which is in another frequency band f3. The hexagonal structure around the first cell 102 defines the communication territory of the first cell 102. The communication territory is the area in which the BTS, included in a cell, can transmit information or data. These communication territories are shown adjacent to each other for illustration but they may also be overlapping with each other geographically (collocated). The first BTS 108 has a plurality of communication devices 114, 116, 118, 120, 122, 124, 126 and 128 in its communication territory. The first BTS 108 sends vital information to the plurality of communication devices 114 to 128 through a common channel in the cell 102. The vital information can pertain to scanning, redirection, etc. for the plurality of communication devices 114 to 128. The vital information is encoded in a configuration message and sent over the common channel for the plurality of communication devices 114 to 128. For example, the first BTS 108 can transmit the configuration message to the plurality of communication devices 114 to 128 through the common channel. Examples of the plurality of communication devices 114 to 128 can be laptops, mobiles, personal digital assistants, etc. The plurality of communication devices 114 to 128 can transfer information or data among themselves through the wireless network 100.

The plurality of communication devices 114 to 128 can transfer information in a communicating state or an idle state. When the plurality of communication devices 114 to 128 is in the communicating state, they can interact with each other to transfer data or information. Alternatively, when the plurality of communication devices 114 to 128 is in the idle state, they can be in an ‘ON’ state or in an ‘OFF’ state. When in the ‘ON’ state, the plurality of communication devices 114 to 128, can receive the vital information from the first BTS 108 through the common channel during their respective paging slot periods. The paging slot of any communication device can be defined as a time interval during which a communication device transits from the ‘OFF’ state to the ‘ON’ state to look for the configuration message from the BTS. For example, in the ‘ON’ state, the plurality of communication devices 114 to 128 searches for the vital information encoded in the configuration message in their respective paging slot period. In turn, the BTS 108 sends the vital information to the plurality of communication devices 114 to 128 by transmitting the configuration message. If the plurality of the communication devices 114 to 128 detect a change in the redirection parameters, then the plurality of communication devices 114 to 128 will stay ‘ON’ to decode the message and act accordingly—the communication devices that are subjected to the redirection will start acquiring at the target frequency while the communication devices that are not subject to the redirection message will go on with their sleep cycle (enter ‘OFF’ state). Alternatively, if no change in the redirection parameters is detected, the plurality of communication devices 114 to 128 enters in the ‘OFF’ state. Further, in ‘OFF’ state, the plurality of communication devices 114 to 128 save power.

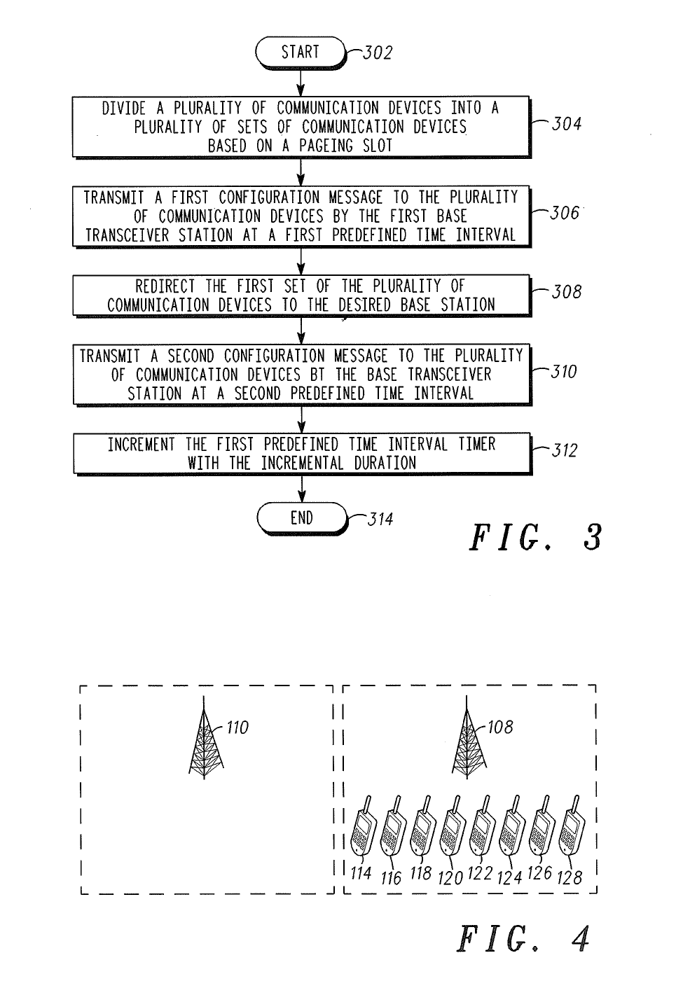

FIG. 2 illustrates a block diagram of the first BTS 108 of the plurality of BTS, in accordance with various embodiments of the present invention. The first BTS 108 sends vital information encoded in the configuration message to the plurality of communication devices 114 to 128. The plurality of the communication devices 114 to 128 decodes the configuration message to detect if they need to be redistributed to any other BTS than the BTS 108 of the plurality of BTS. The first BTS 108 includes a divider 202, a transmitter 204, a timer 206, a register 208, and a determiner 210. The divider 202 of the first BTS 108 virtually divides the plurality of communication devices 114 to 128 into a plurality of sets of communication devices. The plurality of communication devices 114 to 128 are divided on the basis of the paging slot of each of the plurality of the communication devices 114 to 128. During the paging slot, each of the plurality of communication devices 114 to 128 receives the vital information from the first BTS 108 in the ‘ON’ state. The paging slots of the plurality of communication devices are distributed approximately evenly in the paging slot cycle period of BTS 108 so that the plurality of communication devices can share the common channel to receive messages from the BTS and also for an even distribution of the message load on the common channel.

For an embodiment of the present invention, the plurality of communication devices 114 to 128 are divided into a first set of the plurality of communication devices 114, 116, 118 and 120 that are pre-assigned ACCOLC 1 by the operator (or service provider), and a second set of the plurality of communication devices 122, 124, 126 and 128 that are pre-assigned ACCOLC 2 by operator (or service provider). Each of the first set of the plurality of communication devices 114, 116, 118 and 120 has same paging slot period and their paging slots are distributed evenly in the paging slot cycle period, and each of the second set of the plurality of communication devices 122, 124, 126 and 128 has same paging slot period and their paging slots are distributed evenly in the paging slot cycle period. The transmitter 204 is capable of transmitting a plurality of configuration messages to the plurality of communication devices 114 to 128 through the common channel. For an embodiment of the present invention, the transmitter 204 may transmit a first configuration message to the common channel at a first predefined time interval. Further, the transmitter 204 may transmit a second configuration message to the common channel at a second predefined time interval.

The first configuration message and the second configuration message both have different vital information encoded in them. For an embodiment of the present invention, the first configuration message contains new redirection parameters BTS 108 received from its Base Station Controller to be broadcasted to the plurality of communication devices in the communication territory of BTS 108. The second configuration message contains the redirection parameters that were broadcasted to the plurality of communication devices in the communication territory of BTS 108 prior to receiving the new redirection parameters from Base Station Controller. Upon receiving the new redirection parameters, BTS 108 begins transmitting the first configuration message which comprises the new redirection parameters through the common channel for the first predetermined time interval which may be shorter than the paging slot cycle period so that the new configuration message reaches only the plurality of communication devices whose paging slot is in the first predetermined time interval. At the end of the first predetermined time interval, BTS 108 ends the transmission of the first configuration message and starts transmitting the second configuration message which comprises the prior redirection parameters for the second predefined time interval. BTS 108 increases the duration of the first predefined time interval in the next slot cycle period and repeats the same process until the first predefined time interval equals the slot cycle period when the first configuration message is transmitted by BTS 108 full time. The first predefined time interval and the second predefined time interval can be determined on the basis of the paging slot cycle period of the first BTS 108 and the desired number of communication devices to be redirected per paging slot cycle period. The first configuration message is transmitted during the first predefined time interval of the paging slot cycle period and the second configuration message is transmitted during the second predefined time interval where the first predefined interval combined with the second time interval equals the paging slot cycle period of BTS 108. The initial first predefined time interval and the incremental duration of the first predefined time per slot cycle period can be calculated by the estimated number of communication devices to be redirected by the new redirection parameters, the desired communication device registration rate at the target BTS, and the paging slot cycle period of BTS 108.

The timer 206 sets a plurality of predefined time intervals for the transmitter 204 to send the plurality of configuration messages. For an embodiment of the present invention, the timer 206 sets the first and second predefined time intervals for transmitting the first configuration message and a second configuration message, respectively. For another embodiment of the present invention, the first predefined time interval and second predefined time interval can be preprogrammed by a system administrator or a network administrator of the wireless network 100. The register 208 keeps a record of the plurality of communication devices 114 to 128 that are in the communication territory of the first BTS 108. The determiner 210 determines the duration of the plurality of predefined time intervals. For an embodiment of the present invention, the determiner 210 determines the various parameters involved in the algorithms for calculating the incremental broadcast duration and a method of controlling the broadcast duration.

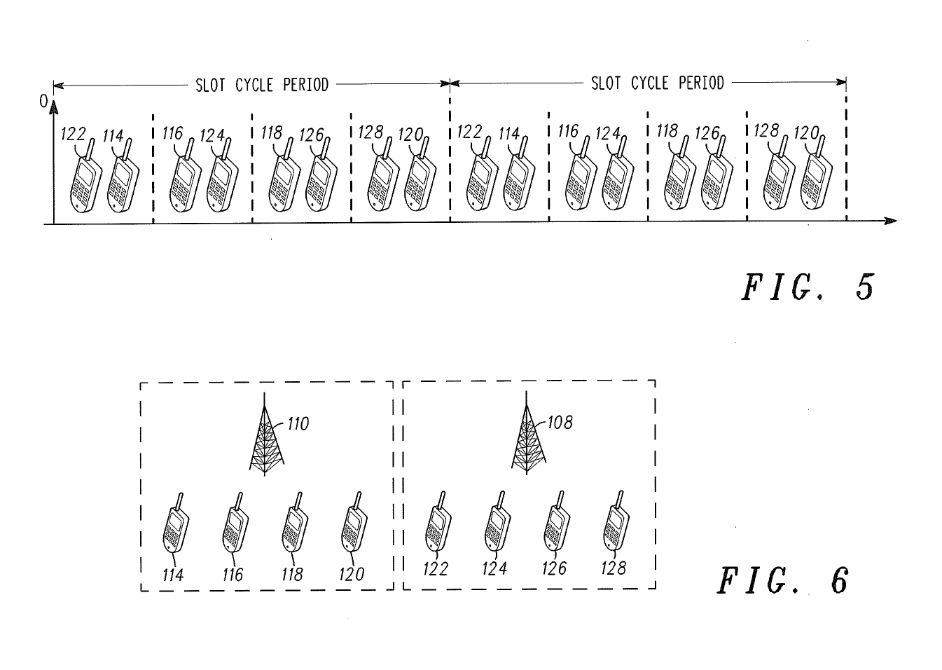

FIG. 3 represents a flow diagram illustrating a method for redistribution of the plurality of communication devices 114 to 128 from the first BTS 108 to the second BTS 110 in the wireless network 100, in accordance with various embodiments of the present invention. The first BTS 108 is in the first frequency band f1 and the second BTS 110 is in the second frequency band f2. The second BTS 110 can be a desired BTS. At step 302, the method for redistributing the plurality of communication devices 114 to 128 is initiated. At step 304, the plurality of communication devices 114 to 128 are divided into a plurality of sets of communication devices. For an embodiment of the present invention, the divider 202 may virtually divide the plurality of communication devices 114 to 128 on the basis of their paging slot. For another embodiment of the present invention, let us consider that the plurality of communication devices 114 to 128 is divided into the first set of the plurality of communication devices 114 to 120 that are of ACCOLC 1, and the second set of the plurality of communication devices 122 to 128 that are of ACCOLC 2. Also let us consider BTS 108 receiving a set of new redirection parameters to redirect ACCOLC 0 and 1 to frequency f2. Prior to this set of new redirection parameters, BTS 108 was redirecting only ACCOLC 0 communication devices to frequency f2. At step 306, the first configuration message is transmitted to the common channel by the first BTS 108 at the first predefined time interval. The first predefined time interval is based on the slot cycle period of the first BTS 108, the number of redirected communication devices, and the desire registration rate at the target BTS, for example BTS 110. The first configuration message has redirection parameters pertaining to the access overload class count (ACCOLC) for the first set of the plurality of communication devices 114 to 120. The ACCOLC is a number within the range 1-15, which is encoded in the configuration message, in addition to the redirection parameters pertaining to the plurality of communication devices 114 to 128. For example, the first configuration message having redirection parameters for the groups of communication devices having ACCOLC 0 and ACCOLC 1 is transmitted by the BTS 108. The first configuration message, when decoded by the first set of the plurality of communication devices 114 to 120, restricts the plurality of communication devices 114 to 120 to access the first BTS 108. At step 308, any of the first set of the plurality of communication devices 114 to 120 that received the first configuration message are redirected to the second BTS 110 in the second frequency band f2 from the first BTS 108 in the first frequency band f1. The first set of the plurality of communication devices 114 to 120 is redirected by decoding the first configuration message.

At step 310, a second configuration message is transmitted to common channel at a second predefined time interval by the first BTS 108. The second predefined time interval is based on the first predefined time interval and the slot cycle period of the first BTS 108. The second configuration message includes encoded redirection parameters prior to the first configuration message, in this particular example, that restricts the group of communication devices of ACCOLC 0 from accessing BTS 108. The second configuration message, when decoded by any of the plurality of communication devices 114 to 128 that entered the “On” state during the second predefined time period would appear to have no effect since the message is identical to the configuration message previously decoded by the communication device. At step 312, BTS 108 increments the timer that controls the first predefined time interval that the first configuration message is transmitted with the calculated incremental duration for the next slot cycle period. The method terminates at step 314 for this slot cycle period and restart at step 302 for the next slot cycle period until the first configuration message is transmitted by BTS 108 for its full slot cycle period.

FIGS. 4, 5 and 6 is an exemplary diagram illustrating the redistribution of the plurality of communication devices 114 to 120 to the second BTS 110, in accordance with various embodiments of the present invention. FIG. 4 shows the plurality of communication devices 114 to 128 in the communication territory of first BTS 108 in the first frequency band f1. The plurality of communication devices 114 to 120 are pre-assigned ACCOLC 1 and the plurality of communication devices 122 to 128 are pre-assigned ACCOLC 2. The divider 202 of the first BTS 108 distributes each of the paging slots of the plurality of communication devices 114 to 128 evenly within the slot cycle period of BTS 108 as shown in FIG. 5. The transmitter 204 of the first BTS 108 transmits the first configuration message to the plurality of communication devices at the first predefined time interval. The first configuration message includes the redirection parameters pertaining to the ACCOLC, which is decoded by a subset of the plurality of communication devices 114 to 128 that enters the “On” state or whose paging slot is within the first predefined time interval. After decoding the first configuration message, each of the first set of the plurality of communication devices 114 to 120 is redirected to the second BTS 110, as shown in FIG. 6. For an embodiment of the present invention, the first set of the plurality of communication devices 114 to 120 are redirected after verifying their respective redirection parameters encoded in the first configuration message.

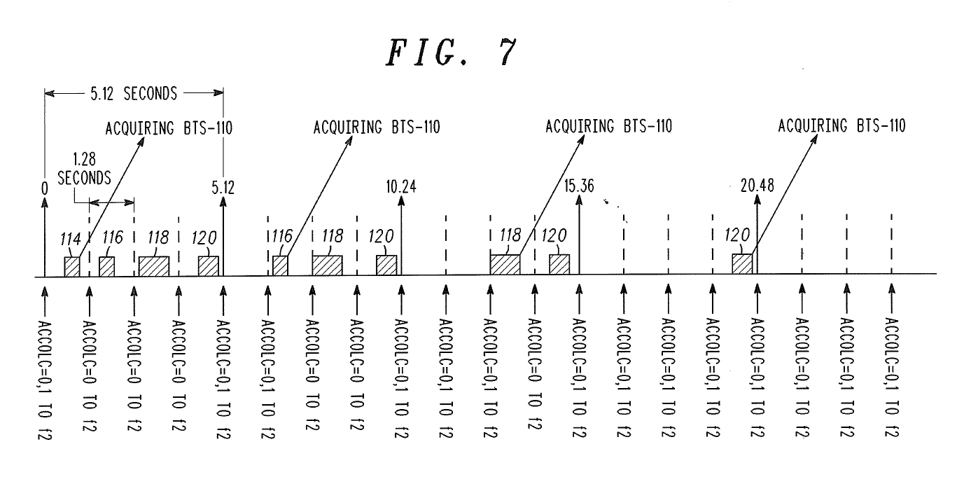

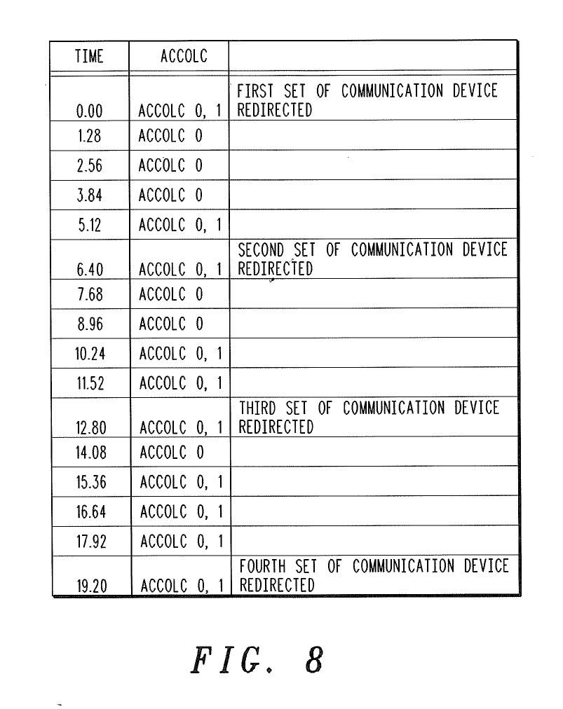

FIG. 7 is an exemplary diagram illustrating the redistribution of the plurality of communication devices 114 to 120 to the second BTS 110, in accordance with another embodiment of the present invention. The time intervals at which a plurality of the configuration messages are to be sent is set by taking into consideration of the number of communication devices to be redirected in one paging slot cycle or the ratio of the number of redirected communication devices per slot cycle period to the total number of redirected communication devices. For an embodiment of the present invention, the time intervals, at which a plurality of the configuration messages is sent by the first BTS 108, can be set by the system administrator or the network administrator of the wireless network 100. For example, the slot cycle of the first BTS 108 is 5.12 seconds and the total number of communication devices to be redirected to BTS 110 is the ACCOLC 1 communication devices 114 to 120 which is a total of 4 devices. Assuming that BTS 110 only permits 1 registration per 5.12 seconds so it is necessary for BTS 108 to redirect only 1 device per slot cycle period or a quarter of the devices per slot cycle period.

For an embodiment of the present invention, let us consider that the plurality of the communication devices can be divided in to four sets of communication devices based on their paging slot position in the paging slot cycle period of BTS 108 as shown in FIG. 5. The first set of communication devices can be communication devices 114 and 122 whose paging slots are in the first quarter of the slot cycle period. The second set of communication devices can be communication devices 116 and 124 whose paging slots are in the second quarter of the slot cycle. The third set of communication devices can be communication devices 118 and 126 whose paging slots are in the third quarter of the slot cycle period. The fourth set of communication devices can be communication devices 120 and 128 whose paging slots are in the forth quarter of the slot cycle period. During the first slot cycle period, 0-5.12 seconds, at a first time interval, i.e., 0-1.28 seconds, a first configuration message, including redirection parameters that redirects communication devices of ACCOLC 0 and 1 to frequency band f2 is transmitted by BTS 108 and decoded by the first set of communication devices 114 and 122. Further, the communication devices 114 of ACCOLC 1 are redirected to the BTS 110, in frequency band f2, based on the redirection parameters. At the second interval of the first slot cycle period, i.e., 1.28-5.12 seconds, a second configuration message, including redirection parameters that redirect communication devices of ACCOLC 0 to frequency band f2 is transmitted by BTS 108 and decoded by the rest of the communication devices 116 to 120 and 124 to 128. Since none of the communication devices is subjected to the second redirection message, no communication device is redirected during the second interval. It should be apparent to a person ordinary skilled in the art that the first configuration message is transmitted during a fraction of the slot cycle period that the only the same fraction of the total communication devices that are subject to the redirection of the first configuration message is redirected after the slot cycle period.

Similarly, at the second slot cycle period, 5.12-10.24 seconds, the transmission time of first configuration message is increased for a quarter of the slot cycle period, i.e., from 5.12-7.68 seconds. At the first quarter of the second slot cycle period, 5.12-6.40 seconds, the first configuration message is transmitted, since communication device 114 of the first set of communication devices has already been redirected and communication device 122 is not subject to the redirection of the first configuration message, no redirection occurred during this interval. At the second quarter of the second slot cycle period, 6.40-7.68 seconds, communication device 116 of the second set of communication devices is redirected. The second configuration message is transmitted the rest of the second slot cycle period and none of the communication devices of the third and forth sets is redirected. Similarly, at the third slot cycle period, 12.80-14.08 seconds, the transmission interval of first configuration message is increased for another quarter of the slot cycle period and communication device 118 of the third set is redirected. The second configuration is transmitted in the forth quarter of the third slot cycle period and none of the communication devices of the forth set is redirected. At the fourth slot cycle period, 15.36-20.48 seconds, the first configuration message is transmitted for the whole slot cycle period. During the forth quarter of the forth slot cycle period, 19.20-20.48 seconds, the fourth set of the plurality of communication devices 120 and 128 decodes the configuration message, and communication device 120 is redirected to the BTS 110.

FIG. 8 shows a table displaying the redirection time of the plurality of communication devices 114 to 120, in accordance with various embodiments of the present invention. The table in FIG. 8 shows the various time intervals in which the plurality of the communication devices 114 to 120 is redirected to the BTS 110. The slot cycle period of the BTS 108 is shown to be 5.12 seconds which is further divided into four time intervals, i.e. 0-1.28 seconds, 1.28-2.56 seconds, 2.56-3.84 seconds, and 3.84-5.12 seconds for the first slot cycle and so on. At the first slot cycle period, i.e. 0-5.12 seconds, the first set of the communication device 114 is redirected in its paging slot between 0-1.28 seconds as shown in the table of FIG. 8. Similarly, the second set of the communication device 116 is redirected in its paging slot between 6.40-7.68 seconds as shown in the FIG. 8. Similarly, the third set of the communication device 118 and the fourth set of the communication device 120 are redirected in their respective paging slots between 12.80-14.08 seconds and 19.20-20.48 seconds.

The method and system described above for redistribution of communication devices in a wireless network reduces channel congestion. Congestion is reduced because redirection of the communication devices does not occur at a particular time but at predefined time intervals that can spread the redirection over a duration longer than a slot cycle period

It will be appreciated that the above mentioned method and system for redistribution of communication devices in a wireless network, described herein. These may comprise one or more conventional processors and unique stored program instructions that control the one or more processors, to implement, in conjunction with certain non-processor circuits, some, most, or all of the functions of the system described herein. The non-processor circuits may include, but are not limited to, signal drivers, clock circuits, power source circuits, and user input devices. As such, these functions may be interpreted as steps of a method for redistribution of communication devices in a wireless network differently. Alternatively, some or all the functions can be implemented by a state machine that has no stored program instructions, or in one or more application-specific integrated circuits (ASICs) in which each function, or some combinations of certain of the functions, are implemented as custom logic. Of course, a combination of the two approaches can also be used. Thus, methods and means for these functions have been described herein.

It is expected that one with ordinary skill, notwithstanding possibly significant effort and many design choices motivated by, for example, available time, current technology and economic considerations, when guided by the concepts and principles disclosed herein, will be readily capable of generating such software instructions, programs and ICs with minimal experimentation.

In the foregoing specification, the invention and its benefits and advantages have been described with reference to specific embodiments. However, one with ordinary skill in the art will appreciate that various modifications and changes can be made without departing from the scope of the present invention, as set forth in the claims below. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage or solution to occur or become more pronounced are not to be construed as critical, required or essential features or elements of any or all the claims. The invention is defined solely by the appended claims, including any amendments made during the pendency of this application, and all equivalents of those claims, as issued.

What is claimed is:

1. A method for redistributing a plurality of communication devices from a first frequency band to a desired frequency band in a wireless network, the plurality of communication devices being in a slotted mode, the method comprising:
dividing the plurality of communication devices into a first and second set of a plurality of communication devices based on the paging slot of each of the plurality of communication devices;
transmitting a first configuration message to the first set of the plurality of communication devices by a first base transceiver station (BTS) at a first predefined time interval of a slot cycle period, wherein the first configuration message comprises encoded a set of new redirection parameters pertaining to an access overload class count of each of the first set of the plurality of communication devices, the first BTS corresponding to the first frequency band;
redirecting each of the first set of the plurality of communication devices to the desired frequency band based on the first configuration message;
transmitting a second configuration message to the plurality of the communication devices by the first BTS at a second predefined time interval of the slot cycle period, wherein the second configuration message comprises encoded redirection parameters prior to the first configuration message; and
incrementing a transmitting interval of the first configuration message and reduce the transmitting interval of the second configuration message in the following slot cycle periods until the first configuration message is transmitted for the full slot cycle period.

2. The method as recited in claim 1 further comprising decoding the first configuration message by the first set of the plurality of communication devices in the first predefined time interval.

3. The method as recited in claim 1 further comprising decoding the second configuration message by the plurality of communication devices in the second predefined time interval.

4. The method as recited in claim 1, wherein the first predefined time interval and the second predefined time interval are based on a paging slot of the first BTS.

5. A Base Transceiver Station (BTS) for redistribution a plurality of communication devices in a wireless network, the BTS comprising:
a divider for virtually dividing the plurality of communication devices into a first set and a second set of plurality of communication devices based on a paging slot of each of the plurality of communication devices; and
a transmitter capable of,
transmitting a first configuration message to the first set of the plurality of communication devices at a first predefined time interval, wherein the first configuration message comprises encoded redirection parameters pertaining to the access overload class count of each of the first set of the plurality of communication devices; and
transmitting a second configuration message to the plurality of communication devices at a second predefined time interval, wherein the first configuration message comprises encoded redirection parameters pertaining to the access overload class count of each of the first set and the second set of the plurality of communication devices.

6. The BTS as recited in claim 5 further comprising a timer for setting the first predefined time interval and the second predefined time interval.

7. The BTS as recited in claim 5 further comprising a register for registering the plurality of sets of communication devices.

8. The BTS as recited in claim 5 further comprising a determiner for determining duration of the first predefined time interval and the second predefined time interval.
